(19) United States
(12) Patent Application Publication
(10) Pub. No.: US 2026/0235360 A1
(43) Pub. Date: Aug. 13, 2026

(54) PROCESS GAS COLLECTION SYSTEMS FOR LUMBER DRYING OPERATIONS

(71) Applicant: Wellons, Inc., Vancouver, WA (US)

(72) Inventor: Cameron D. Houston, Oregon City, OR (US)

(73) Assignee: Wellons, Inc., Vancouver, WA (US)

(21) Appl. No.: 19/535,681

(22) Filed: Feb. 10, 2026

Related U.S. Application Data
(60) Provisional application No. 63/756,417, filed on Feb. 10, 2025.

(51) Int. Cl. F26B 25/00; F26B 15/00; F26B 21/00

(52) U.S. Cl. CPC F26B 25/008; F26B 21/001; F26B 15/00; F26B 2210/16

(57) ABSTRACT

Process gas collection systems for continuous drying systems (CDSs) are shown and disclosed. In some examples, the process gas collection system includes an internal collection manifold, at least one process gas collection port, external collection ductwork, and discharge ductwork. In some examples, the process gas collection system includes at least one flow induction device disposed between the external collection ductwork and the discharge ductwork. In some examples, the process gas collection system includes one or more process gas monitoring assemblies, one or more process gas modification assemblies, and/or one or more heat recovery assemblies.

### CROSS REFERENCE TO RELATED APPLICATIONS

This application claims the benefit of U.S. Provisional Patent Application No. 63/756,417 filed on Feb. 10, 2025 and entitled “Process Gas Collection Systems For Lumber Drying Operations.” The complete disclosure of the above application is hereby incorporated by reference for all purposes.

### BACKGROUND

There has been a lumber industry shift from traditional batch lumber drying systems, often referred to as lumber kilns, which have been around since the early 1900s to more modern and sophisticated continuous lumber drying systems (CDSs) or continuous kilns. CDSs generally include an enclosure or housing having a multitude of internal chambers or sections, typically three or more, for drying lumber. For CDSs with three chambers that progress one or multiple tracks of lumber in the same direction, those chambers are typically referred to as a preheating or first outer chamber, a drying or central chamber, and a cooling or second outer chamber. In those systems, the central chamber is disposed between the first and second outer chambers. For CDSs with three chambers that progress one or multiple tracks of lumber in opposite directions (often referred to as counterflow CDSs), the two outer chambers are typically referred to as energy recovery chambers, while the central chamber is referred to as the drying chamber.

Historically, emissions from lumber drying processes (“process gases”) have been indirectly regulated via restrictions based on the total production capacity of lumber drying systems and emission factors derived from limited-scale research testing due to a lack of suitable collection and sampling provisions on lumber drying systems. Such approaches, however, can inaccurately estimate emissions produced, which can lead to unnecessary curtailments in production. While these regulations were initially developed for batch kiln lumber drying technologies, which operate differently from CDSs, current CDSs in the market similarly lack alternative solutions for emissions regulation. They continue to vent process gases directly to the atmosphere through multiple ports/vents and allow process gases to escape through other uncontrolled means, such as through doors and other openings, without any opportunity for real-time monitoring or treatment. Further compounding the issue, many CDSs supply gases—typically air—to the drying chamber, which forces process gases outward toward the exterior chambers, resulting in uncontrolled venting or fugitive releases of those gases to the surrounding environment.

What is desired, therefore, is an improved process gas collection system for capturing, monitoring, and/or treating process gases from lumber drying operations. Such a system would address at least some of the shortcomings of current technologies by enabling real-time emissions monitoring, reducing fugitive emissions by drawing gases inward, and/or providing opportunities for effective treatment methods, which would reduce environmental impact and allow for optimized production that is free from unnecessary curtailments.

### BRIEF DESCRIPTION OF THE DRAWINGS

For a better understanding of the invention, and to show how the same may be carried into effect, reference will now be made, by way of example, to the accompanying drawings, in which:

FIG. 1 shows a side view of an example of a process gas collection system of the present disclosure;

FIG. 2 shows an isometric view of the process gas collection system of FIG. 1;

FIG. 3 shows a partial bottom view of the process gas collection system of FIG. 1 showing an example of an internal exhaust manifold;

FIGS. 4-5 show partial isometric views of the internal exhaust manifold of FIG. 3;

FIG. 6 shows a partial isometric view of the internal exhaust manifold showing an example of movable dampers;

FIG. 7 shows a partial isometric view of the process gas collection system of FIG. 1 showing an example of a process gas collection port;

FIG. 8 shows a side view of the process gas collection port of FIG. 7;

FIG. 9 shows an isometric view of a section of another example of an internal collection manifold of the process gas collection system of FIG. 1;

FIG. 10 shows a partial view of the internal collection manifold of FIG. 9;

FIG. 11 shows an isometric view of a section of a further example of an internal collection manifold of the process gas collection system of FIG. 1; and

FIGS. 12-13 show sectional view of the internal collection manifold of

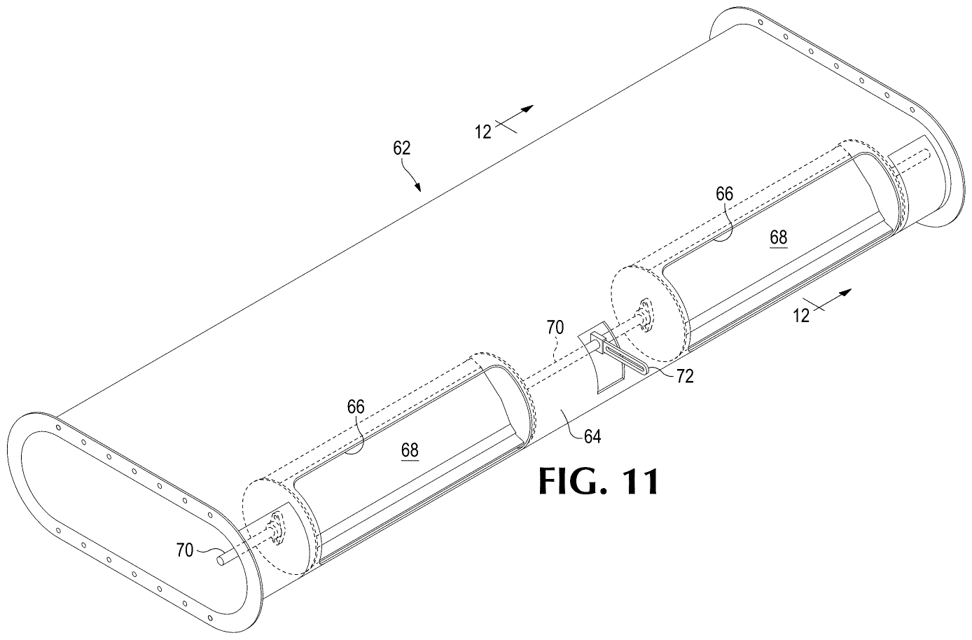

FIG. 11 taken along lines 12-12 in FIG. 11.

### DETAILED DESCRIPTION

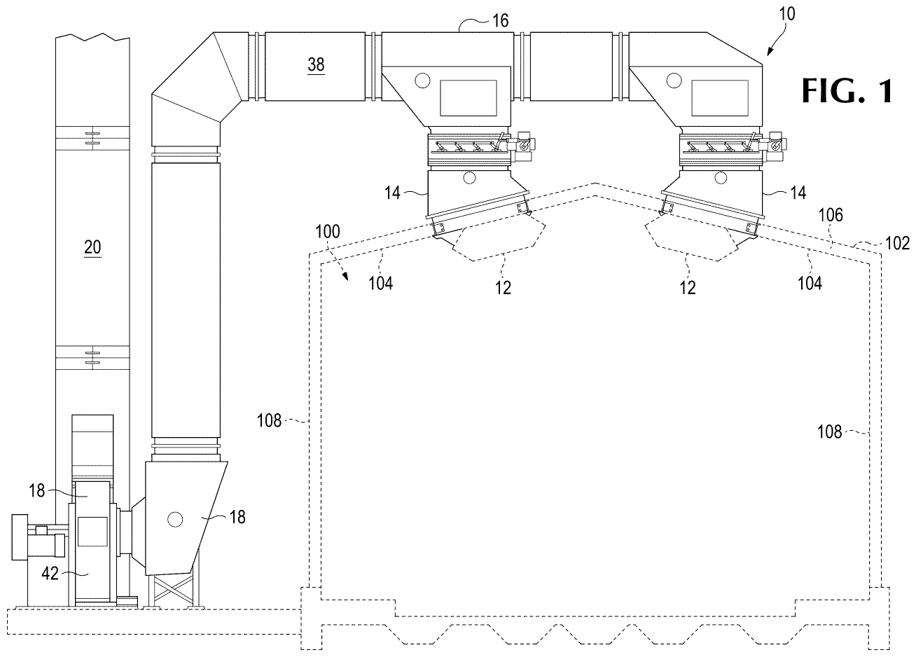

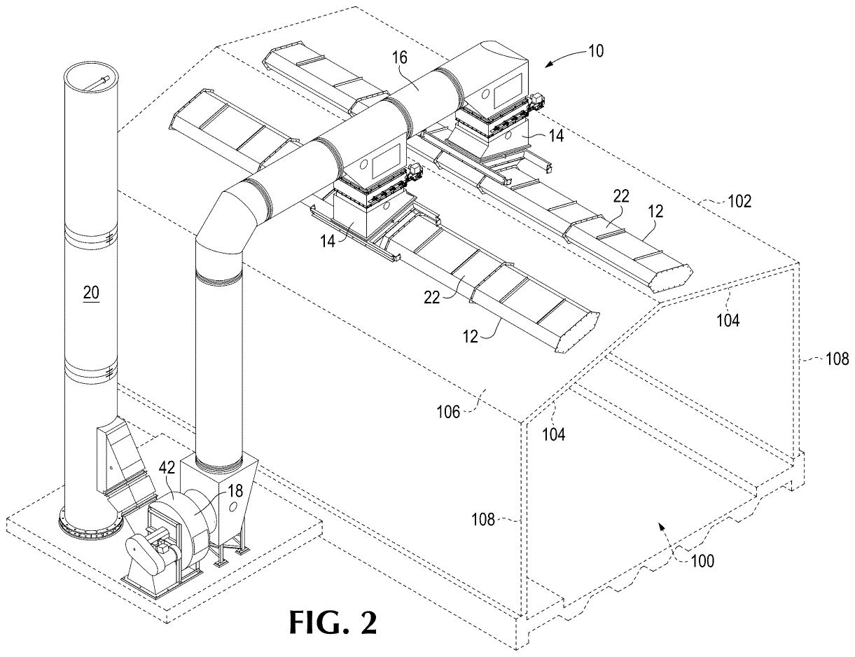

Referring to FIGS. 1-2, an example of a process gas collection system 10 is shown. The process gas collection system includes an internal collection manifold 12, a process gas collection port 14, external collection ductwork 16, a flow induction device (or forced extractor) 18, and discharge ductwork 20. Other examples of the process gas collection system may exclude one or more components, such as, for example, the flow induction device and/or the internal collection manifold.

Internal collection manifold 12 is positioned or disposed within an internal compartment 100 of a CDS enclosure 102 (or CDS chamber) and extends adjacent to the internal ceiling 104 of that enclosure. Unless explicitly excluded, internal collection manifold 12 may include the same or similar components and/or structures of one or more other internal collection manifolds in the present disclosure. In some examples, the internal collection manifold is fixedly attached to the roof 106, such as fixedly attached to the internal ceiling of the roof with the roof connecting opposed side walls 108. Although collection manifold 12 is shown to be completely internal and contained within the CDS enclosure, other examples of process gas collection system 10 may have collection manifolds that are partially or completely external the CDS enclosure.

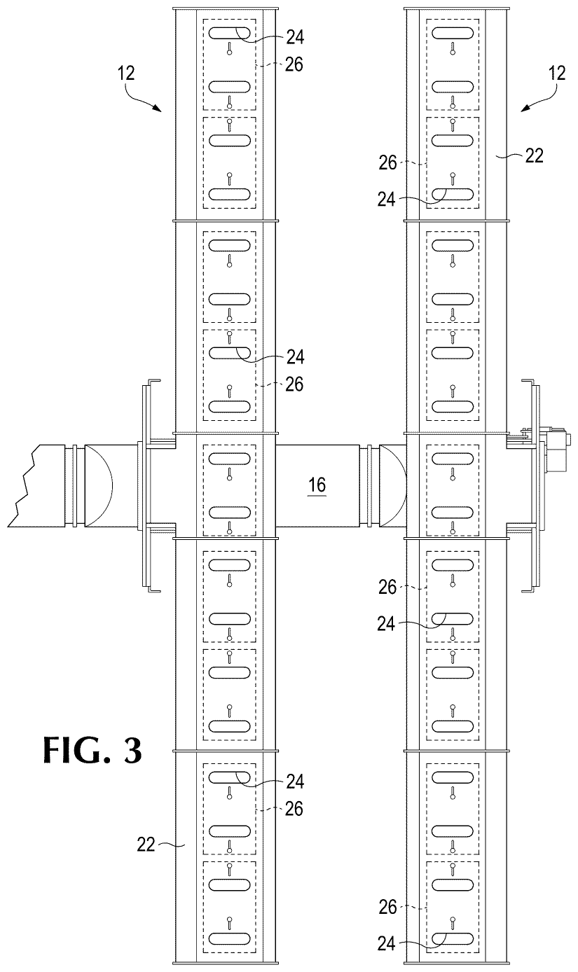

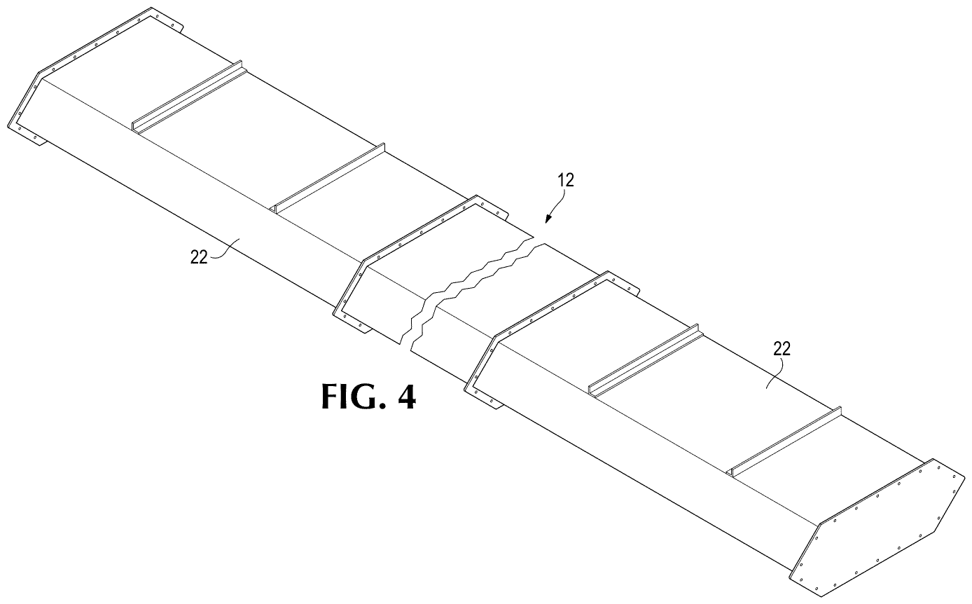

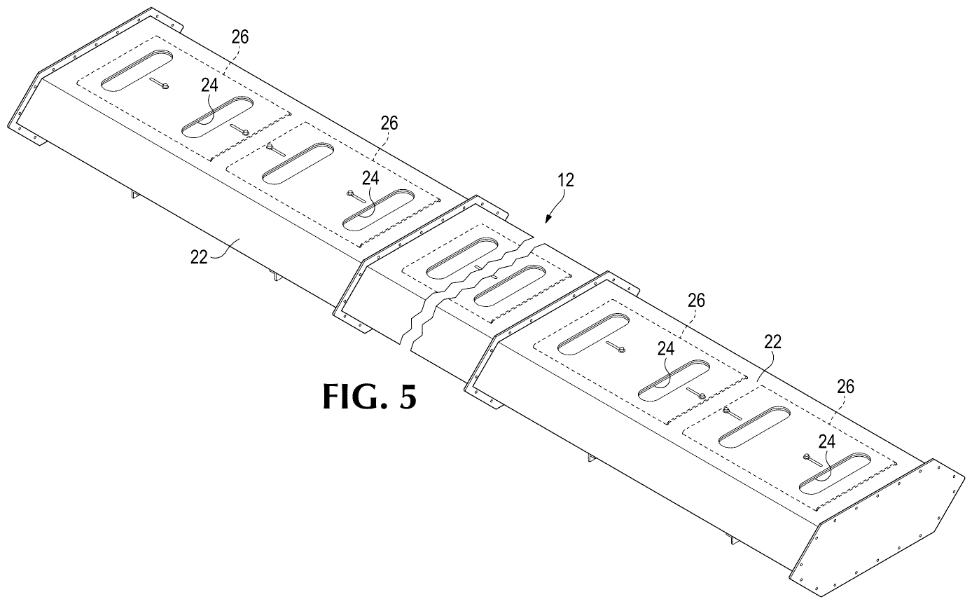

As best shown in FIGS. 3-6, the internal collection manifold includes an elongate enclosed manifold base 22 having a plurality of openings 24 along its length. The openings are stadium-shaped in the example of FIGS. 3-6, but can be any suitable shape(s) in other examples. In some examples, the length of the base is sufficient to allow collection of process gases from one, multiple, or all sections within CDS 100 chamber, such as pre-heating, heating, and cooling sections (not shown) of the CDS chamber.

In the example shown in FIGS. 3-6, manifold base 22 is an elongate and hollow structure with a hexagonal cross-section (or hexagonal prism) but other examples of the manifold base may alternatively, or additionally, include other suitable shape(s), such as a cuboid, a cylinder, a rectangular prism, or a triangular prism. Additionally, manifold base 22 may be a single section or include a plurality of sections fixed attached via flange ends of the sections and fasteners. Moreover, manifold base 22 does not include any internal walls and has only external walls that define the interior passage for the processes gases. Other examples of manifold base 22 may, however, include one or more internal walls. One or more components of the internal collection manifold may be made of any suitable materials, such as sheet aluminum.

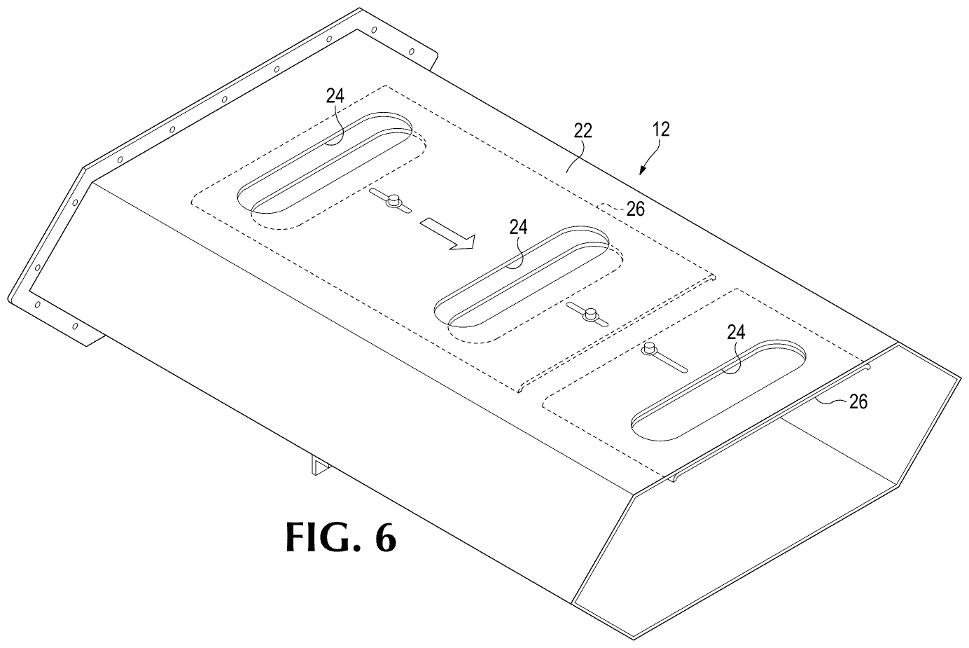

Process gas collection system 10 shown in FIGS. 1-2 includes two distinct and separate internal collection manifolds 12, which can be used independently or collectively. However, other examples of the process gas collection system may include a single internal collection manifold 12 or three or more internal collections manifolds 12. Additionally, the elongate internal collection manifolds in FIGS. 1-2 are parallel to the longitudinal axis of the CDS chamber. In some examples, internal collection manifold 12 includes movable or slidable dampers 26 with each damper allowing a user to selectively completely cover, partially cover, and completely uncover one or more of openings 24 to control the amount of process gases entering the internal collection manifold at any portion along the length of the manifold, as best shown in FIG. 6. In other examples, the internal collection manifold may include motors and/or actuators (not shown) to adjust one or more of the dampers. The dampers may, in some examples, be adjusted automatically as a response to process conditions inside the CDS chamber, such as temperature, humidity, weather, moisture, species, push rate, and/or other production factors. In some examples, the internal collection manifold may be disposed on one or both sides of a fan wall (not shown) that divides the internal compartment defined by the enclosure longitudinally.

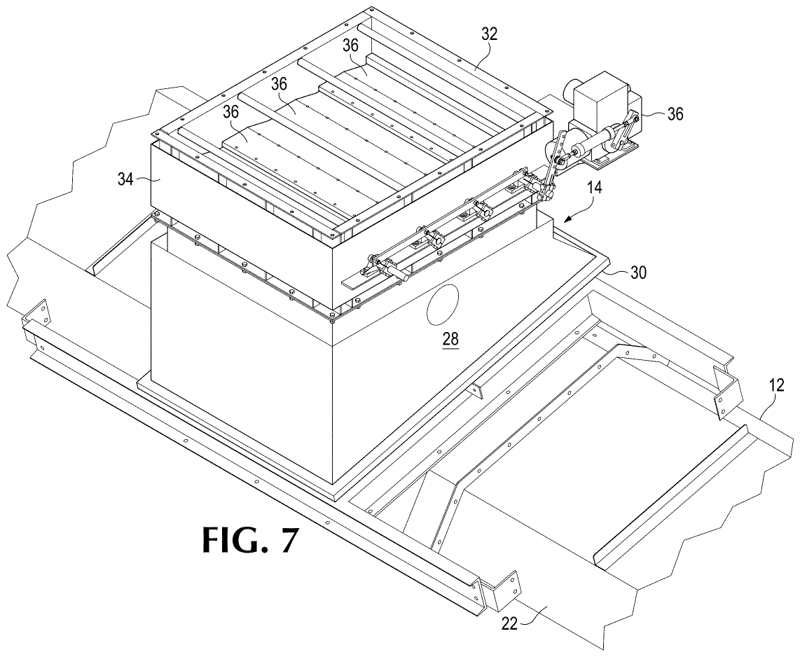

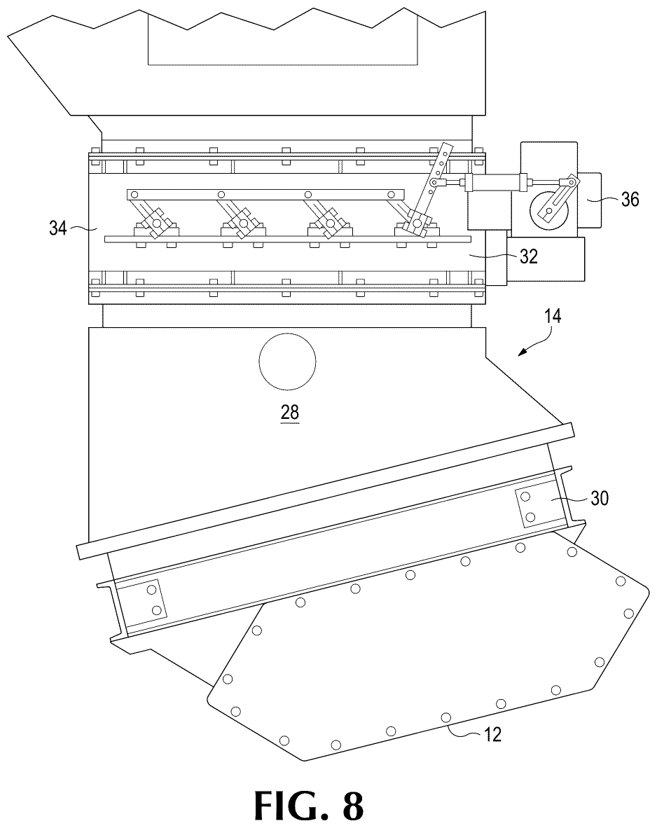

Referring to FIGS. 1-2 and 7-8, the process gas collection system includes at least one process gas collection port 14 for each internal collection manifold 12. The port connects the internal collection manifold that is located within the CDS chamber to the other components of the process gas collection system that are located external to that chamber. The port facilitates the transition of process gases into the external collection ductwork, which enables a controlled extraction of process gases from the CDS chamber Additionally, the port supports selective gas collection depending on operational factors, such as fan direction and internal chamber environment conditions (e.g., dry bulb temperature, wet bulb temperature, relative humidity, air velocity, pressure, lumber species or dimensions, other production factors, etc.). In the example shown in FIGS. 1-2 and 7-8, port 14 includes a duct 28 and a supporting frame 30 (e.g., steel support). Additionally, an actuated duct damper assembly 32 having a damper base 34, one or more port dampers 36 rotatably attached to the damper base, and a motor 36 configured to selectively rotate the port damper(s) to control the rate of process gas collection or process gas flow from the CDS chamber.

Other examples of the process gas collection system may exclude port damper(s) 36 and/or may include one or more flow devices (not shown) and/or one or more restriction orifices (not shown). Additionally, in examples in which an internal collection manifold 12 is not included in the process gas collection system, a process gas collection port 14 could be used in one or multiple locations throughout the CDS chambers to collect process gases directly without the internal collection manifold from the CDS chamber and direct them to discharge via the external collection ductwork.

Referring back to FIGS. 1-2, external collection ductwork 16 couples process gas collection ports 14 with flow induction device 18 and/or discharge ductwork 20. External collection ductwork includes an elongate hollow ductwork base 38. The ductwork base may be continuous or be made of several sections. Additionally, the ductwork base made of one or more suitable materials, such as metal. In the example shown in FIGS. 1-2, the ductwork base is cylindrical but the ductwork base may be one or more other suitable shapes in other examples. Additionally, the ductwork base may be cladded and/or insulated. Moreover, the ductwork may include a plurality of monitoring ports (not shown) for process gas monitoring (e.g., tap ports, flange faces, pipes, plugs, caps, etc.). The ductwork may exclude any internal walls within the internal compartment of ductwork base 38 or may include one or more internal walls.

Flow induction device 18 is disposed between and connects external collection ductwork 16 with discharge ductwork 20. The flow induction device draws process gases from upstream components, such as external collection ductwork 16, and discharges that gas through discharge ductwork 20. In some examples, the flow induction device may include one or more powered fans 42. In other examples, flow induction device 18 may be excluded, such as when the circulating fans (not shown) within the CDS chamber and/or vapor pressure and/or convective forces within that chamber has sufficient motive force.

Referring to FIGS. 1-2, discharge ductwork 20 is directly coupled to flow induction device 18 and disperses process gases to the atmosphere at an acceptable location, such as above the roof of the CDS chamber. In the example shown in FIGS. 1-2, the discharge ductwork includes an elongate, hollow, and vertically-oriented cylindrical duct or pipe. Other examples of the discharge ductwork may include one or more alternative shapes. The discharge ductwork may be cladded and/or insulated and may include one or more discharge ports (not shown) for process gas monitoring (e.g., tap ports, flange faces, caps, etc.).

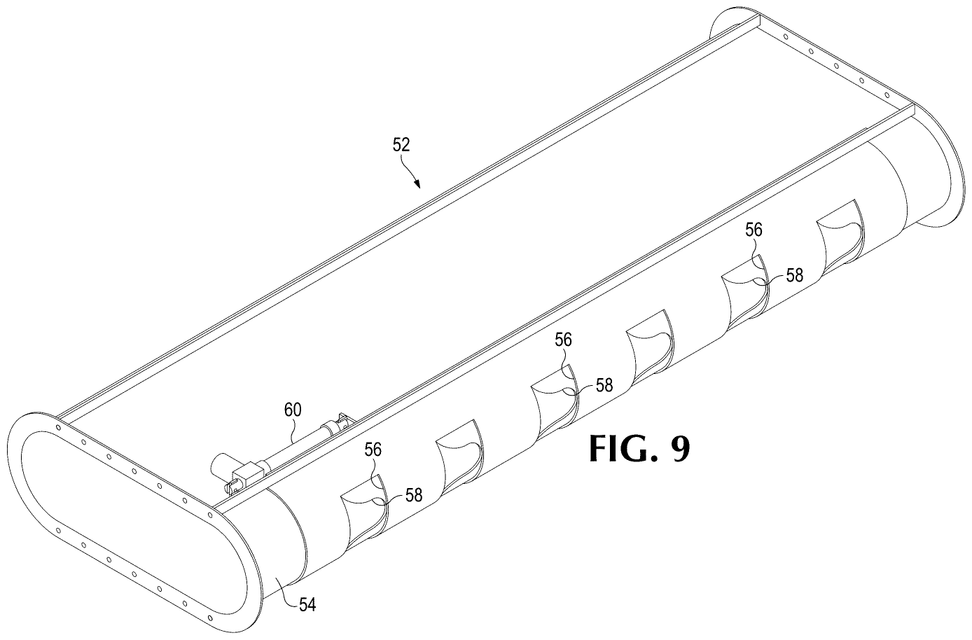

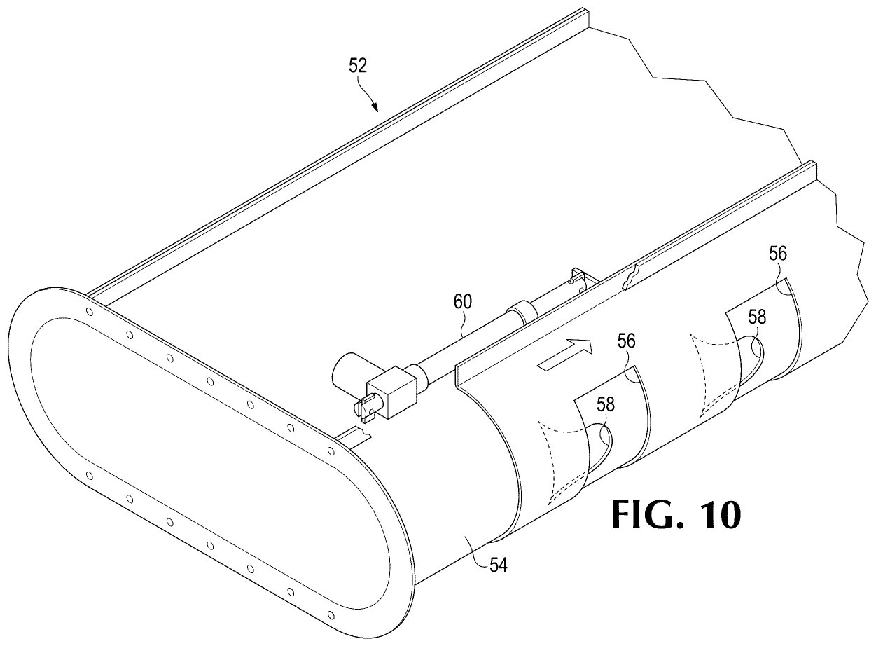

Referring to FIGS. 9-10, another example of internal collection manifold 12 is shown and generally indicated at 52. Unless explicitly excluded, internal collection manifold 52 may include the same or similar components and/or structures of one or more other internal collection manifolds in the present disclosure. Unlike internal collection manifold 12, internal collection manifold 52 includes manifold base sections 54 with a has a stadium-shaped cross section. Each manifold base section 54 has openings 56 along one or both transverse ends of manifold base section. Additionally, for each manifold base section 54, slidable dampers 58 are all connected together and are actuated or moved via a link 60 connected to a motor (not shown) to move between a closed position in which the dampers cover the openings and prevent the process gases from flowing through the openings, and an open position in which the dampers are spaced from the openings relative to the closed position and allow the process gases to flow through the openings. Link 60 from two or more (or all) manifold base sections 54 may be connected to allow a single motor (not shown) to move the slidable dampers.

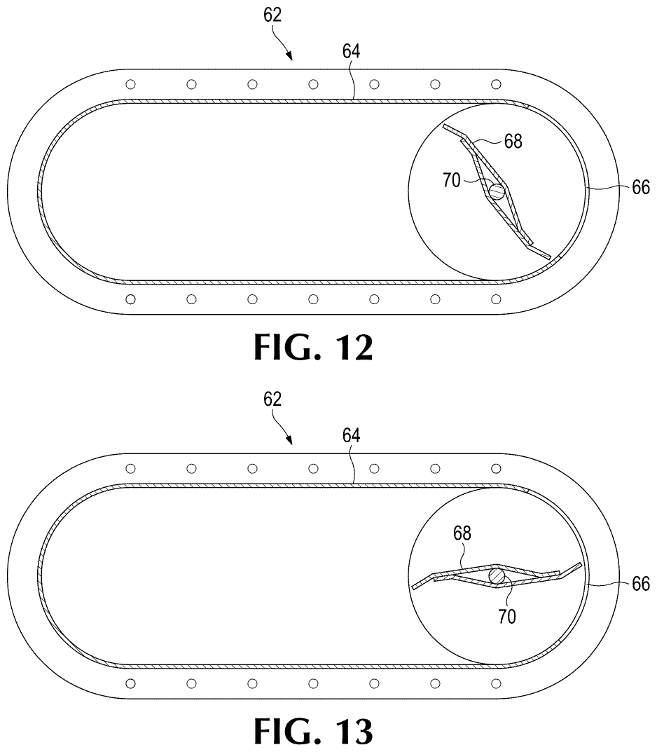

Referring to FIGS. 11-13, another example of internal collection manifold 12 is shown and generally indicated at 62. Unless explicitly excluded, internal collection manifold 62 may include the same or similar components and/or structures of one or more other internal collection manifolds in the present disclosure. Internal collection manifold 62 is similar to internal collection manifold 52. However, unlike internal collection manifold 52, internal collection manifold 62 includes manifold base sections 64 each having a plurality of openings 66 and rotatable dampers 68 that are connected together on a single axle 70 and are actuated or moved via a link 72 connected to a motor (not shown) to move between a closed position in which the dampers cover the openings and prevent the process gases from flowing through the openings, and an open position in which the dampers are spaced from the openings relative to the closed position and allow the process gases to flow through the openings. The axle and/or the link of two or more (or all) manifold base sections 64 may be connected together to allow a single motor (not shown) to move the rotatable dampers between the closed and open positions.

In some examples, the process gas collection system may include one or more process gas monitoring assemblies (not shown), which can be installed at any suitable location (including directly coupled to, or within the CDS chamber), such as via one or more tap ports at the inlet and outlet end portions of the external collection ductwork or at the process gas collection ports. The data collected can provide information regarding process gases to regulatory bodies, operators, and/or computerized control system(s) on variables such as particular matter, volatile organic compounds (VOCs), methanol, formaldehyde, acetaldehyde, temperature, flowrate, humidity, and other process gas compliance criteria that can be used to confirm regulatory criteria or modified existing operating conditions in the CDS. The monitoring assemblies may include a National Council for Air and Stream Improvement (NCASI) chilled impinger (not shown), which captures emissions into a chilled impinger train and may include a probe, a heated filter, water-filled impingers, a rotameter, a critical orifice, an on/off valve, and/or a pump. The chilled impinger train is specifically designed for methanol and formaldehyde.

Alternatively, or additionally, the monitoring assemblies may include an Environmental Protection Agency (EPA) method 25A assembly (not shown), which measures total gaseous organic concentrations as carbon in emissions and may include a calibration valve, particulate filtrations, and/or an organic analyzer and recorder. The EPA method 25A assembly is particularly useful for quantifying volatile organic compounds (VOCs). The monitoring assemblies may alternatively, or additionally, include gas chromatography (GC) devices (not shown) in which methanol collected in a chilled impinger solution is analyzed. The GC devices separate and quantify methanol based on its volatility and interaction with the GC column. The monitoring assemblies may alternatively, or additionally, include colorimetric devices (not shown) in which formaldehyde in the process gases is made to react with acetyl-acetone to form a yellow chromophore, which can then be quantified via a spectrophotometer. The colorimetric devices are used for low-concentration formaldehyde measurements. Data from the monitoring assemblies may be used to modify one or more operating conditions of the CDS, such as temperature, humidity, air flow, heat input, lumber advancement, and/or overall production.

In some examples, the process gas collection system may include one or more process gas modification assemblies (not shown), which may be disposed in any suitable locations within that system, such as between the external collection ductwork and the flow induction device and/or discharge ductwork. The process modification assemblies remove undesirable components from the process gases. An example of a process gas modification assembly includes at least one thermal oxidizer (not shown) in which the process gases are exposed to a heat release source that elevates the process gas temperatures. The thermal oxidizer includes a heat release source (e.g., burner) and a burner/mixing chamber. After sufficient thermal energy has been transferred to the process gases, the gases exit the modification assemblies and are discharged through the discharge ductwork. Other examples of process gas modification assemblies include chemical injection assemblies, temperature adjustment assemblies, condensers, and filtration assemblies.

In other examples, the process gas collection system may include one or more heat recovery assemblies (not shown), which may include at least one heat exchanger or mixing chamber located downstream of the process modification assembly. The heat recovery assemblies receive thermal energy from the modified process gas stream and then transfer the thermal energy to a recirculation air system directly coupled to the CDS chamber for use in heating the CDS lumber drying processes, such as heating the interior of the CDS chamber. Some examples of the process gas collection system may include both a process modification assembly and a heat recovery assembly, other examples of the process gas collection system may include only a heat recovery assembly without a process modification assembly, or vice-versa. Some examples of the process gas collection system may include one or more process gas monitoring assemblies, one or more process gas modification assemblies, and one or more heat recovery assemblies.

Unlike existing systems that strive to supply air into or allow vapor to build pressure in a central chamber that pushes process gases outward toward exterior chambers, the process gas collection system of the present disclosure draws the process gases inward toward the centrally located process gas collection system. Specifically, the process gas collection system of the present disclosure is a substantial improvement from prior CDS systems because it significantly alters the dynamics of the process gas flow by causing process gases from outer or exterior chambers to migrate toward the process gas collection systems (e.g., pre-heating and cooling chambers toward drying chamber and into the process gas collection system). As a result, process gases from the CDS system are effectively directed to a central collection point for monitoring and/or modification/treatment to alter the state and/or properties of process gases into the environment.

The process gas collection systems of the present disclosure are stand-alone systems that do not have an air or other fluid intake assemblies and structures associated with those assemblies. In other words, any air and/or fluid intake assemblies would be separate and distinct from the process gas collection systems of the present disclosure.

Below are numbered paragraphs that describe additional examples of the process gas collection systems of the present disclosure.
Paragraph 1 A process gas collection system for a CDS, comprising:
a process gas collection port that is fluidly connected to at least one interior compartment of the CDS;
external collection ductwork that is fluidly connected to the process gas collection port.
Paragraph 2 The system of paragraph 1, further comprising an internal collection manifold that is fluidly connected to the at least one interior compartment, wherein the process gas collection port is fluidly connected to the internal collection manifold.
Paragraph 3 The system of any of paragraphs 1-2, further comprising discharge ductwork that is fluidly connected to the external collection ductwork and discharges at least a portion of the process gases received in the external collection ductwork.
Paragraph 4 The system of any of paragraphs 1-3, wherein the process gas collection system further includes a flow induction device to draw process gases from the internal collection manifold toward the discharge ductwork.
Paragraph 5 The system of paragraph 4 in which the flow induction device is a fan.
Paragraph 6 The system of any of paragraphs 1-5, wherein the process gas collection system includes one or more process gas monitoring assemblies that measure one or more variables of the process gas.
Paragraph 7 The system of paragraph 6, wherein the one or more process gas monitoring assemblies include at least one of a NCASI chilled impinger assembly, an EPA method 25A assembly, a gas chromatography assembly, or a colorimetric assembly.
Paragraph 8 The system of any of paragraphs 1-7, wherein the process gas collection system includes one or more process modification assemblies.
Paragraph 9 The system of paragraph 8, wherein the one or more process gas modification assemblies include at least one thermal oxidizer, condenser, chemical injection, or filtration.
Paragraph 10 The system of any of paragraphs 1-9, wherein the process gas collection system includes one or more heat recovery assemblies.
Paragraph 11 The system of paragraph 10, wherein the one or more heat recovery assemblies include at least one heat exchanger or mixing chamber.
Paragraph 12 A continuous drying system, comprising:
an enclosure that receives lumber and that includes a central section disposed between first and second outer sections; and
the process gas collection system of any of paragraphs 1-11.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

What is claimed is:

1. A process gas collection assembly for a continuous kiln, the continuous kiln including a housing having opposed side walls and a roof connecting the side walls, the side walls and roof defining an internal compartment, the assembly comprising:
at least one elongate internal collection manifold disposed within the at least one interior compartment and fixedly attached to the roof, the at least one internal collection manifold configured to receive process gases from the internal compartment;
at least one process gas collection port that is external the housing and fluidly connected to the at least one internal collection manifold;
external collection ductwork that is external the housing and fluidly connected to the at least one process gas collection port;
discharge ductwork that is external the housing and fluidly connected to the external collection ductwork and that discharges at least a portion of the process gases received in the external collection ductwork; and
a flow induction device disposed between the external collection ductwork and the discharge ductwork, the flow induction device being configured to draw process gases from the internal collection manifold toward the discharge ductwork.

2. The assembly of claim 1 in which the flow induction device is a fan.

3. The assembly of claim 1, wherein the internal collection manifold includes a manifold base and a plurality of openings spaced along at least a substantial portion of a length of the base.

4. The assembly of claim 3, wherein the internal collection manifold further includes at least one movable damper that moves relative to the manifold base between a closed position in which the at least one damper covers one or more openings of the plurality of openings, and an open position in which the at least one damper is spaced from the one or more openings relative to the closed position.

5. The assembly of claim 1, wherein the at least one process gas collection port includes one or more adjustable dampers.

6. The assembly of claim 1, wherein the internal collection manifold includes a hollow and elongate base that defines an internal passage to receive the process gases from the internal compartment.

7. The assembly of claim 6, wherein the internal collection manifold does not include any internal walls within the internal passage.

8. The assembly of claim 1, wherein the hollow and elongate base is parallel to a longitudinal axis of the kiln.
